(19) United States
(12) Patent Application Publication
(10) Pub. No.: US 2013/0082677 A1
(43) Pub. Date: Apr. 4, 2013

(54) OUTPUT DRIVING DEVICE

(71) Applicant: SAMSUNG ELECTRO-MECHANICS CO., LTD., Gyeonggi-do (KR)

(72) Inventor: Chang Jae Heo, Gyeonggi-do (KR)

(73) Assignee: SAMSUNG ELECTRO-MECHANICS CO., LTD., Gyeonggi-do (KR)

(21) Appl. No.: 13/626,824

(22) Filed: Sep. 25, 2012

(30) Foreign Application Priority Data
Sep. 30, 2011 (KR) 10-2011-0099539

(51) Int. Cl. G05F 3/02

(52) U.S. Cl. 323/317

(57) ABSTRACT

The present invention is related to an output driving device. The output driving device includes: a stabilization unit for generating a correction voltage with a level lower than a power voltage; a first buffer unit for generating a first driving voltage with a swing width; a second buffer unit for generating a second driving signal with a swing width; and an output driving unit for generating an output signal in response to the first and the second driving signals. Accordingly, by supplying a plurality of driving signals with swing widths different from each other corresponding to the characteristics of each output unit respectively, it can set the gate voltage flown into the first output unit not to exceed the breakdown voltage between the gate and the source of the first output unit and can protect the devices of the first output unit as the PMOS transistor.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0099539, entitled filed Sep. 30, 2011, which is hereby incorporated by reference in its entirety into this application.

### BACKGROUND OF THE INVENTION

1. Field of the Invention

The present invention relates to an output driving device; and, more particularly to an output driving device including a PMOS transistor.

2. Description of the Related Art

Among various components constituting of a semiconductor integrated circuit, an output driver, i.e., an output driving device is a part to transfer the output data to another external chip by finally driving the data.

In general, the output driver includes a pull-up transistor, hereinafter referring to as a first output unit, formed of a PMOS transistor to increase the voltage of the output signal and a pull-down transistor, hereinafter referring to as a second output unit, formed of an NMOS transistor to decrease the voltage of the output signal.

And, since a large load is connected to an output terminal of the output driving device, the first output unit and the second output unit have the driving capability greater than the transistor used inside of the semiconductor integrated circuit.

On the other hand, the first output unit as described above can be formed with the PMOS transistor. The operation voltage of the PMOS transistor is determined by the breakdown voltage between the source and the drain, the breakdown voltage between the source and the gate and the breakdown voltage between the gate and the drain, and among these the breakdown voltage between the source and the gate is set as the most smallest value.

And then, in case when the power voltage VCC supplied to the PMOS transistor is smaller than the breakdown voltage between the source and the drain and larger than the breakdown voltage between the source and the gate, since it is smaller than the breakdown voltage between the source and the drain, the power voltage is applied to the source terminal of the PMOS transistor and there is no problem even though the ground voltage is connected to the drain terminal.

However, in order to operate the PMOS transistor, if the signal of the power voltage level and the signal of the ground voltage level are applied to the gate terminal, the power voltage is applied to the voltage between the source and the gate, and the voltage between the source and since the gate is larger than the breakdown voltage between the source and the gate there frequently occurs in case that the PMOS transistor is broken down.

Accordingly, although the power voltage is smaller than the breakdown voltage between the source and the drain, if it is larger than the breakdown voltage between the source and the gate, the output driving device requires for an additional circuit or construction to make the operation voltage of the source and the gate voltage to drive the PMOS transistor not to be larger than the voltage between the source and the gate.

### SUMMARY OF THE INVENTION

The present invention has been invented in order to overcome the above-described problems and it is, therefore, an object of the present invention to provide an output driving device capable of protecting the PMOS transistor device by controlling the swing width of the signal supplied to the gate voltage of the PMOS transistor not to exceed the breakdown voltage between the gate and the source of the PMOS transistor.

In accordance with one aspect of the present invention to achieve the object, there is provided an output driving device including: a stabilization unit for generating a correction voltage with a level lower than a power voltage; a first buffer unit for generating a first driving voltage with a swing width between the correction voltage and the power voltage by receiving an input signal; a second buffer unit for generating a second driving signal with a swing width between an inner voltage and a ground voltage by receiving the input signal; and an output driving unit for generating an output signal in response to the fist driving signal and the second driving signal outputted from the first buffer unit and the second buffer unit.

In accordance with another aspect of the present invention to achieve the object, there is provided an output driving device including: a stabilization unit for generating a correction voltage and a reference voltage with a level lower than a power voltage; a level shift unit for generating a shift signal by shifting a level of an input signal to a level corresponding to the correction voltage and the power voltage; an inverter unit for generating a first driving signal by receiving and inverting the shift signal outputted from the level shift unit; a peak current limiting unit, formed between the inverter unit and nodes to supply the correction voltage of the stabilization unit, for limiting a peak current generated during a switching operation of the inverter unit; a buffer unit for generating a second driving signal with a swing width between an inner voltage and a ground voltage by receiving the input signal; and an output driving unit for generating an output signal in response to the fist driving signal and the second driving signal outputted from the inverter unit and the buffer unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing an output driving device in accordance with a first embodiment of the present invention;

FIG. 2 is a detail circuit diagram showing the output driving device in accordance with the first embodiment of the present invention;

FIG. 3 is a block diagram showing an output driving device in accordance with a second embodiment of the present invention;

FIG. 4 is a detail circuit diagram showing the output driving device in accordance with the second embodiment of the present invention;

FIG. 5 is a block diagram showing an output driving device in accordance with a third embodiment of the present invention; and

FIG. 6 is a detail circuit diagram showing a stabilization unit of FIG. 2.

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

The terms used throughout this specification are provided to describe embodiments but not intended to limit the present invention. In this specification, a singular form includes a plural form unless the context specifically mentions. When an element is referred to as “comprises” and/or “comprising”, it does not preclude another component, step, operation and/or device, but may further include the other component, step, operation and/or device unless the context clearly indicates otherwise.

Hereinafter, the constructions of the present invention and function effects thereof will be described in detail with reference to the accompanying drawings.

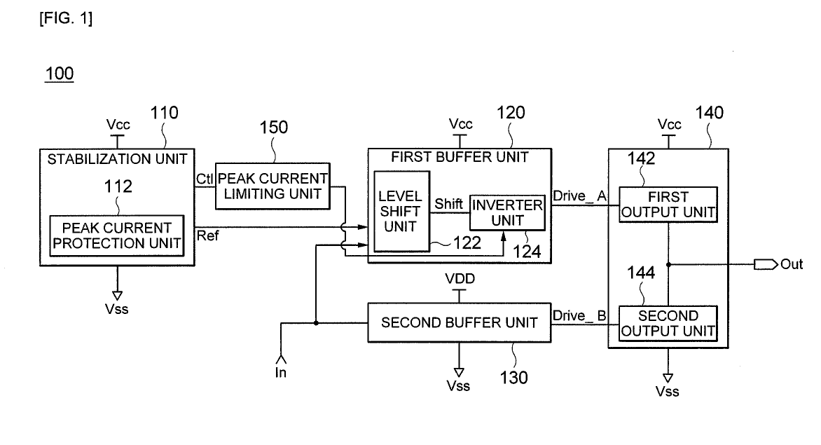

FIG. 1 is a block diagram showing an output driving device in accordance with a first embodiment of the present invention.

Referring to FIG. 1, the output driving device 100 in accordance with the first embodiment of the present invention includes a stabilization unit 110, a first buffer unit 120, a second buffer unit 130 and an output driving unit 140.

The stabilization unit 130 can generate a reference voltage Ref having a voltage lower than a power voltage VCC and a correction voltage Ct1 based on the reference voltage Ref. At this time, the generated correction voltage Ct1 and the reference voltage Ref may be supplied to a first buffer unit 120.

In addition, the stabilization unit 120 can further include a peak current protection unit 112 in order to prevent a peak current generated when the first buffer unit 120 is shifted from a low level to a high level or from the high level to the low level from being flown.

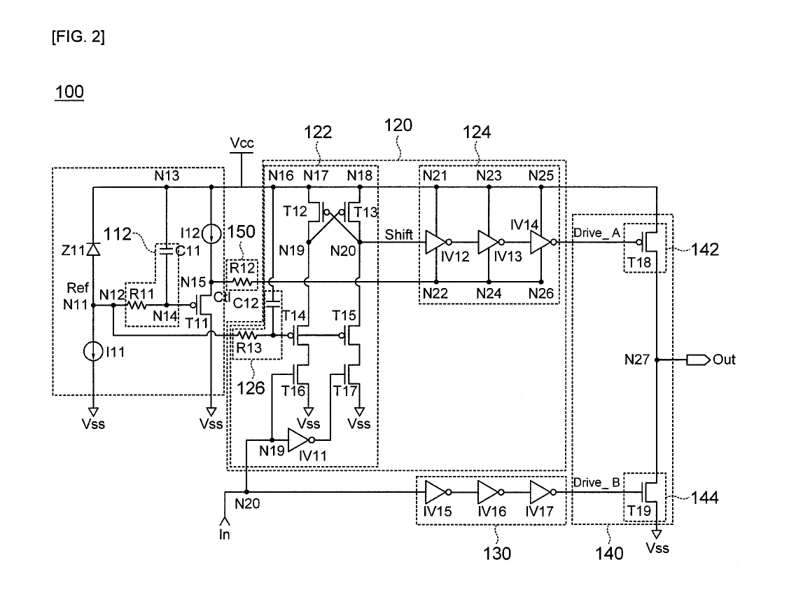

As like this, since the stabilization unit 110 in accordance with the present invention can control a voltage supplied to the output driving unit 140 by supplying the correction voltage Ct1 to the first buffer unit 120, it can stabilize in such a way that a gate voltage of a transistor (T18 of FIG. 2) of the first output unit 142 of the output driving unit do not exceed a threshold voltage between a source and a gate.

The first buffer unit 120 can supply as a gate signal of the first output unit 142 of the output driving unit 140 by generating a first driving signal Drive_A having a swing width the correction voltage Ct1 and the power voltage VCC supplied from the stabilization unit 110.

The first buffer unit 120 can include a level shift unit 122 for generating a shift signal by shifting a level of an inputted input signal In to a level corresponding to the correction voltage Ct1 and the power voltage VCC and an inverter unit 124 for generating a first driving signal Drive_A having a swing width between the correction voltage Ct1 and the power voltage VCC.

The second buffer unit 130 may generate a second driving signal Drive_B by inverting the input signal In and output the generated second driving signal Drive_B to a second output unit 144. At this time, the swing width of the second driving signal Drive_B may have a swing width between a ground voltage VSS and an inner voltage VDD with a level lower than the power voltage.

The output driving unit 140 includes a first output unit 142 for receiving the first driving signal Drive_A of the first buffer unit 120 as a gate signal and a second output unit 144 for receiving the second driving signal Drive_B of the second buffer unit as a gate signal. At this time, it can be designed in such a way that if the first output unit 142 is activated, the second output unit 144 is not activated; and if the second output unit 144 is activated, the first output unit 142 is not activated.

On the other hand, the output driving device 100 in accordance with the present invention can prevent the reference voltage Ref and the correction voltage Ct1 from being changed due to the unwanted operation of the stabilization unit 1110 by introducing excessive peak current generated in the first buffer unit 120 into the stabilization unit 110 by forming the peak current limiting unit 150 between the stabilization unit 110 and the first buffer unit 120.

As described above, the output driving device 100 in accordance with the present invention can supply the first driving signal Drive_A having the swing width between the correction voltage Ct1 and the power voltage VCC in the first output unit 142 and supply the second driving signal Drive_B having the swing width between the inner voltage VDD and the ground voltage VSS.

Like this, the reasons for supplying the driving signals having the swing widths different from each other to each of the output units are to set the gate voltage flown into the first output unit 142 not to exceed the breakdown voltage between the gate and source and to protect the device of the first output unit 142 by this.

In addition, the output driving device 100 can maintain the level of the reference voltage Ref generated in the stabilization unit 110 uniformly always by forming the peak current protection unit 112 and the peak current limiting unit 150 inside of the stabilization unit 110 and on the output terminal of the stabilization unit 110.

FIG. 2 is a detail circuit diagram showing the output driving device in accordance with the first embodiment of the present invention.

As shown in FIG. 2, the output driving device 100 in accordance with the first embodiment of the present invention includes a stabilization unit 110, a first buffer unit 120, a second buffer unit 130 and an output driving unit 140.

The stabilization unit 110 can be formed by including a Zener diode Z11, a first current source 111, a second current source 112, a PMOS transistor T11 and a peak current protection unit 112.

The Zener diode Z11 and the first current source 111 can be formed as a first current path by being connected in series between the power voltage terminal VCC and the ground voltage terminal VSS.

And, the second current source 112 and the PMOS transistor T11 may be formed as a second current path by being connected in series between the power voltage terminal VCC and the ground voltage terminal VSS as well as be connected to the first current path in parallel.

The peak current protection unit 112 can be connected between the first current path and the second current path and, for example, may be constructed by an RC circuit.

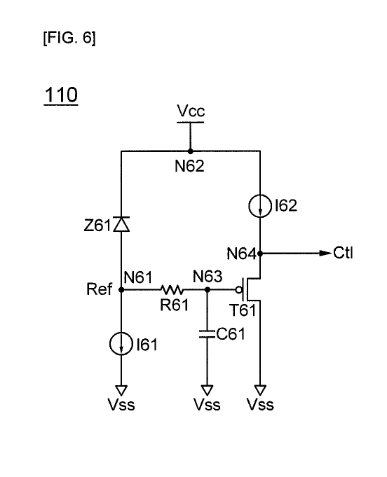

More particularly, a resistor R11 of the peak current protection unit 112 is connected between an eleventh node N11 and a PMOS transistor T11 and a capacitor C11 of the peak current protection unit 112 is connected the power voltage terminal VCC and a fourteenth node N14 formed on the output terminal of the resistor R11. But, the capacitor C11 of the peak current protection unit 112 is not limited to the first embodiment of the present invention, but, as shown in FIG. 6, may be formed by being connected between a 63th node N63 formed at the output terminal of the resistor R61 and the ground voltage terminal.

The peak current protection unit 112 can prevent the voltage change of the 11^{th} node N11 by preventing the peak current flown through a 15^{th} node N15 connected to the source terminal of the PMOS transistor from flowing into the 11^{th} node N11 side formed between the Zener diode Z11 and the first current source 111 and can maintain the level of the reference voltage Ref by this.

As describing more particularly, if the first driving signal Drive_A is outputted to the output driving unit 140 in the first buffer unit 120, since the peak current is flowing temporarily, the peak current flows into the gate side of the PMOS transistor T11 of the stabilization unit 110.

Accordingly, if the peak current temporally flown to the 15^{th} node N15 is flown into the 14^{th} node N14 through a parasitic cap between the source and the gate of the PMOS transistor T11, the peak current protection unit 112 can prevent the current from flowing into the Zener diode Z11 or the first current source 111 by charging the capacitor C11. Therefore, the reference voltage Ref of the 11^{th} node N11 can be maintained stably and the voltage, i.e., the correction voltage Ct1, of the 15^{th} node N15 connected to the source of the PMOS transistor can also maintained stably at the same time. h

The first buffer unit 120, connected to an output terminal of the stabilization unit 110, can be constructed by including a level shift unit 122 and an inverter unit 124.

The level shift unit 122 can generate a shift signal by shifting the level of the inputted input signal In to the level corresponding to the correction voltage Ct1 and the power voltage VCC.

The level shift unit 122, as shown in FIG. 2, can be constructed by including a first input transistor T16, a second input transistor T17, a first mirror transistor T12 and a second mirror transistor T13.

Explaining the operation of the level shift unit 122, if the input signal with a high level is inputted, the first input transistor T16 of the level shift unit 122 is activated; and, accordingly, the voltage of the 19^{th} node N19 becomes low. And then, the second mirror transistor T13 is also activated together, in this results, the voltage of the 20^{th} node N20 is increased according to the power voltage supplied from the power voltage terminal VCC. Accordingly, the level shift unit 122 can output the shift signal of a high level corresponding to the power voltage.

On the other hand, when the input signal of the high level is inputted, the second input transistor T17 does not operate by being inactive since an input signal of a low level is received by an inverter IV11 connected to a front end.

On the other hand, the first input transistor T16 of the level shift unit 122 becomes inactive and only the second input transistor T17 becomes active when the input signal of the low level is inputted. Accordingly, the voltage of the 20^{th} node N20 becomes low. At this time, the voltage of the 20^{th} node N20 becomes low to the level of the reference voltage according to the activation status of the second reference transistor T15. That is, the level shift unit 122 can generate the shift signal of the low level corresponding to the level of the reference voltage Ref and supply it to the first output unit 142.

On the other hand, the level shift unit 122 can further include a first reference transistor T14 and a second transistor T15. As the first reference transistor T14 and the second transistor T15 can receive the reference voltage Ref as a gate signal, when the voltage at the source terminal of the second transistor T15, that is, the voltage of the 20^{th} node N20, has a low level, the voltage at the source terminal of the second reference transistor T14 can be controlled so as not to exceed a breakdown voltage between the source and the gate of the first mirror transistor T12, the second mirror transistor T13 and the inverter unit 124. That is, the first reference transistor T14 and the second reference transistor T15 can protect the first mirror transistor T12, the second mirror transistor T13 and the inverter unit 124.

And, the level shift unit 122 can further include a current prevent unit 126 formed of an RC circuit to prevent the peak currents generated during the on/off operation of the inverter unit 124 into the gates of the first and the second reference transistors from being flown into the stabilization unit 110.

The inverter unit is formed by connecting 3 numbers of inverters IV12, IV13 and IV14 in series and can generate the first driving signal Drive_A having a swing width of the correction voltage Ct1 and the power voltage VCC by inverting the shift signal outputted from the level shift unit 122.

And, the second buffer unit 130 in accordance with the present invention is formed by connecting 3 numbers of inverters IV15, IV16 and IV17 in series and can generate the second driving signal Drive_B having a swing width between the inner voltage VDD and the ground voltage VSS by inverting the input signal In.

The output driving unit 140 includes a first output unit 142 for receiving a first driving signal Drive_A of the first buffer unit 120 as a gate signal and a second output unit 144 for receiving a second driving signal Drive_B of the second buffer unit 130 as a gate signal. At this time, the first output unit 142, for example, may be a PMOS transistor T18, and the second output unit 144, for example, may be an NMOS transistor T19.

On the other hand, the output driving device 100 in accordance with the present invention can prevent the reference voltage Ref and the correction voltage Ct1 from not being maintained at a constant level due to the malfunction of the stabilization unit 110 by introducing the excessive peak current generated in the first buffer unit 120 into the stabilization unit 110 by forming the peak current limiting unit 150 between the stabilization unit 120 and the first buffer unit 120. At this time, the peak current limiting unit 150, for example, may be formed of a resistor R12.

As described above, the output driving device 100 in accordance with the present invention can supply the first driving signal Drive_A having a swing width of the correction voltage Ct1 and the power voltage VCC in the first output unit 142 and can supply the second driving signal having a swing width between the inner voltage VDD and the ground voltage VSS in the second output unit 144.

Like this, the output driving device 100 in accordance with the present invention sets the gate voltage flown into the first output unit 142 not to exceed the breakdown voltage between the gate and the source of the first output unit 142 by supplying the driving signals having the swing widths different from each other corresponding to the characteristic of each output unit and can protect the devices of the first output unit 142.

Like this, as the driving signals having the swing widths different from each other in each output unit are supplied, the gate voltage flown into the first output unit 142 is set not to exceed the breakdown voltage between the gate and the source of the first output unit 142 and can protect the devices of the first output unit 142.

In addition, the output driving device 100 can maintain the level of the reference voltage Ref generated in the stabilization unit 110 uniformly always by forming the peak current protection unit 112 and the peak current limiting unit 150 in the stabilization unit 110 and at the output terminal of the stabilization unit 110.

Hereinafter, the operation of the output driving device in accordance with the present invention will be explained.

Before the explanation, at first, the driving power voltage of the present invention assumes, for example, 15V and inner voltage VDD assumes 5V; and assumes that it has a device with an operation voltage between the source and the gate of the transistor of the first output unit 142 below 5.5V, an operation voltage between the source and the drain below 30V and an operation voltage between the source and the gate of the transistor of the inverter unit 124 below 5.5V.

If the output driving device 100 receives a power voltage as 15V, the reference voltage Ref applied to the 11^{th} node N11 has 10V, more specifically 10V+Vth, dropped by the threshold voltage Vz of the Zener diode in the power voltage terminal VCC. In this result, the voltage of the source terminal of the PMOS transistor T11 of the stabilization unit 110 can have 10V. That is, if the voltage difference between the power voltage VCC and the 15^{th} node N15 maintains below 5V, since the gate voltage of the inverter unit 124 and the first output unit 142 is maintained below 5V, the devices can be protected by making the swing width, i.e., the range of operation voltage, of the inverter unit 124 and the first output unit 142.

And, as the voltage of the input signal In of the present invention is a signal having a swing width of 0˜5V, the voltage of the input signal In can be supplied as the gate signal of the first output unit 142 by being generated as the first driving signal Drive_A having the swing width of 10˜15V through the first buffer unit 120. And, the voltage of the input signal In can be supplied as a gate signal of the second output unit 144 by being generated as the second driving signal Drive_B having a swing width of 0˜5V through the second buffer unit 130. In this result, the output driving unit 140 can generate and output the output signal Out having a swing width of 0˜15V.

Like this, the output driving device 100 in accordance with the present invention sets the gate voltage flown into the first output unit 142 so as not to exceed the breakdown voltage between the gate and the source of the first output unit 142 by supplying the driving signals having the swing widths different from each other corresponding to the characteristic of each output unit and can protect the devices of the first output unit 142.

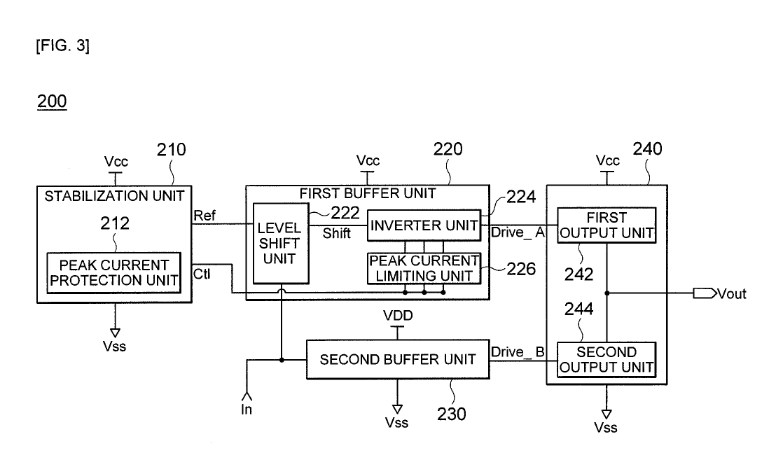

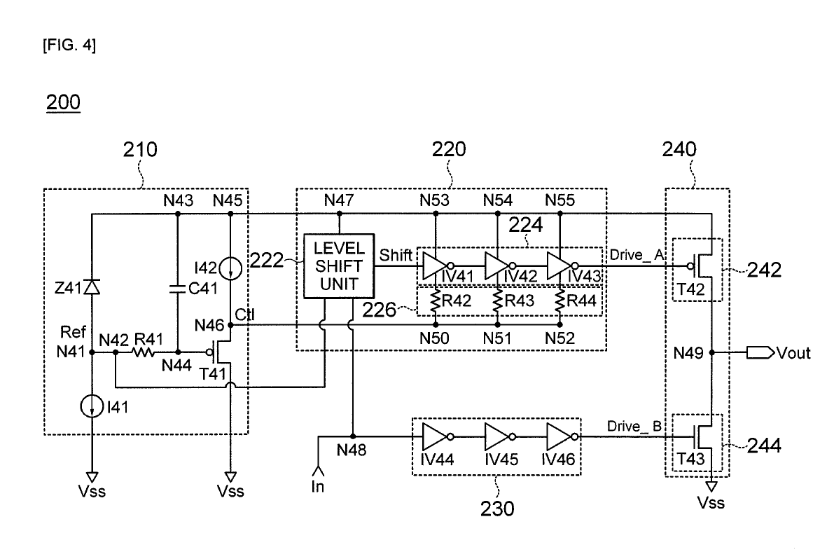

FIG. 3 is a block diagram showing an output driving device in accordance with a second embodiment of the present invention; and FIG. 4 is a detail circuit diagram showing the output driving device in accordance with the second embodiment of the present invention.

As shown in FIG. 3, the output driving device 200 in accordance with the second embodiment of the present invention includes a first buffer unit 220, a second buffer unit 230 and an output driving unit 240. Since the stabilization unit 210, the second buffer unit 230 and the output driving unit 240 in accordance with the second embodiment of the present invention have the same constructions as the stabilization unit 110, the second buffer unit 130 and the output driving unit 140, the detailed explanation thereof will be omitted and only the first buffer unit 220 will be explained.

The first buffer unit 220 in accordance with the second embodiment of the present invention generates the first driving signal Drive_A having a swing width between the correction voltage Ct1 and the power voltage VCC supplied from the stabilization unit 210 and can supply the generated first driving signal Drive_A as a gate signal of the first output unit 242 of the output driving unit 240.

The first buffer unit can be constructed by including a level shift unit 222 for generating the shift signal by shifting the level of the inputted input signal In to the level corresponding to the correction voltage Ct1 and the power voltage VCC, an inverter unit 224 for generating the first driving signal Drive_A having the swing width between the correction voltage Ct1 and the power voltage VCC by inverting the shift signal outputted from the level shift unit 222 and a peak current limiting unit 226 for limiting the excessive peak current flown from the first output unit 242 to a predetermined level during the switching operation of the inverter unit 224 by being formed between the nodes to supply the correction voltages Ct1 of the inverter unit 224 and the stabilization unit 210.

The above-described peak current limiting unit 226, as shown in FIG. 4, for example, may be formed of a plurality of resistors R42, R43 and R44 and each of the resistors R42, R43 and R44 may be connected so as to correspond a plurality of inverters IV41, IV42 and IV43 formed each of the inverter units 224.

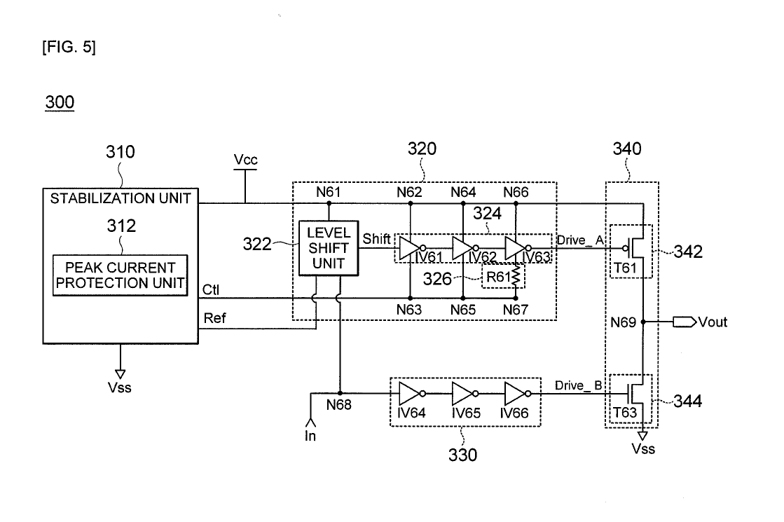

However, during the switching operation of the inverter unit 224, since the region where the largest peak current flows is the 3^{rd} inverter IV43 formed nearest distance from the first output unit 242 among the plurality of inverters IV41, IV42 and IV43, the peak current limiting unit 226 is not limited to the second embodiment of the present invention but it can be connected to only the 3^{rd} inverter IV63, as shown in FIG. 5.

Like this, the output driving device 200 in accordance with the present invention can prevent the correction voltage Ct1 from being changed by applying the generated excessive peak current to the stabilization unit 210 by forming the peak current limiting unit 226 to the second voltage supply of the inverter unit 224.

The output driving device in accordance with the embodiments of the present invention can set the gate voltage flown into the first output unit not to exceed the breakdown voltage between the gate and the source of the first output unit and can protect the devices of the first output unit as the PMOS transistor by supplying a plurality of driving signals with swing widths different from each other corresponding to the characteristics of each output unit respectively.

In addition, the output driving device in accordance with the embodiments of the present invention can prevent the excessive peak current generated during the switching operation of the buffer unit from being flown into the stabilization unit by forming the peak current protection unit in the stabilization unit as well as forming the peak current limiting unit between the stabilization unit and the first buffer unit or in the first buffer unit at the same time.

This invention may be embodied in different forms and should not be construed as limited to the embodiments set forth herein. Rather, these embodiments are provided so that this disclosure will be thorough and complete, and will fully convey the scope of the invention to those skilled in the art. As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An output driving device comprising:
a stabilization unit for generating a correction voltage with a level lower than a power voltage;
a first buffer unit for generating a first driving voltage with a swing width between the correction voltage and the power voltage by receiving an input signal;
a second buffer unit for generating a second driving signal with a swing width between an inner voltage and a ground voltage by receiving the input signal; and
an output driving unit for generating an output signal in response to the fist driving signal and the second driving signal outputted from the first buffer unit and the second buffer unit.

2. The output driving device according to claim 1, wherein the stabilization unit includes:
a first current path including a Zener diode and a first current source connected in series;
a second current path, connected to the first current path in parallel, including a second current source and a transistor connected in series; and
a peak current protection unit, connected between the first current path and the second current path, for preventing a peak current generated during a switching operation of the first buffer unit from flowing into the stabilization unit.

3. The output driving device according to claim 2, further comprising a peak current limiting unit, formed between the stabilization unit and the first buffer unit, for preventing a peak current above a predetermined current from flowing into the stabilization unit.

4. The output driving device according to claim 1, wherein the first buffer unit includes:
a level shift unit for generating a shifting signal by shifting a level of the input signal to a level corresponding to the correction voltage and the power voltage; and
an inverter unit for generating a first driving signal by inverting the shift signal outputted from the level shift unit.

5. The output driving device according to claim 4, wherein the inverter unit includes a plurality of inverters connected to each other in series.

6. The output driving device according to claim 1, wherein the second buffer unit includes a plurality of inverters connected to each other in series.

7. The output driving device according to claim 2, wherein a reference voltage generated by a node formed between the Zener diode and the first current source is applied to the level shifter unit.

8. The output driving device according to claim 2, wherein the correction voltage is determined by a voltage of a source terminal of the transistor.

9. The output driving device according to claim 1, wherein the inner voltage is a voltage of a level smaller than a level of the driving voltage.

10. An output driving device comprising:
a stabilization unit for generating a correction voltage and a reference voltage with a level lower than a power voltage;
a level shift unit for generating a shift signal by shifting a level of an input signal to a level corresponding to the correction voltage and the power voltage;
an inerter unit for generating a first driving signal by receiving and inverting the shift signal outputted from the level shift unit;
a peak current limiting unit, formed between the inverter unit and nodes to supply the correction voltage of the stabilization unit, for limiting a peak current generated during a switching operation of the inverter unit;
a buffer unit for generating a second driving signal with a swing width between an inner voltage and a ground voltage by receiving the input signal; and
an output driving unit for generating an output signal in response to the fist driving signal and the second driving signal outputted from the inverter unit and the buffer unit.

11. The output driving device according to claim 10, wherein the level shift unit includes a peak current protection unit so as to prevent a level of the correction voltage from being changed since the peak current is flown into the stabilization unit.

12. The output driving device according to claim 11, wherein the peak current protection unit is formed of an RC circuit.

13. The output driving device according to claim 10, wherein inverter unit is formed of a plurality of inverters.

14. The output driving device according to claim 10, wherein the peak current limiting unit is formed of a plurality of resistors.

15. The output driving device according to claim 14, wherein each of the resistors is connected by being corresponded to the plurality of inverters one by one.

16. The output driving device according to claim 10, wherein the peak current limiting unit is formed of one resistor.

17. The output driving device according to claim 14, wherein each of the resistors is connected to an inverter formed on a region nearest to the output driving unit among the plurality of inverters.

18. The output driving device according to claim 10, wherein the stabilization unit includes:
a first current path including a Zener diode and a first current source connected in series;
a second current path, connected to the first current path in parallel, including a second current source and a transistor connected in series; and
a peak current protection unit, connected between the first current path and the second current path, for preventing a peak current generated during a switching operation of the first buffer unit from flowing into the stabilization unit.

19. The output driving device according to claim 10, wherein the correction voltage is determined by a voltage at a source terminal of the transistor.

20. The output driving device according to claim 10, wherein the reference voltage is determined by a voltage of a node formed between the Zener diode and the first current source.

21. The output driving device according to claim 10, wherein the reference voltage is a voltage lower than the correction voltage.

22. The output driving device according to claim 10, wherein the inner voltage is a voltage of a level smaller than a level of the driving voltage.
